(19) United States
(12) Patent Application Publication
(10) Pub. No.: US 2005/0182962 A1
(43) Pub. Date: Aug. 18, 2005

(54) Computer security peripheral

(76) Inventors: Paul Given, Lakewood, CO (US); Scott Eugene Farleigh, Thorton, CO (US)

Correspondence Address: LATHROP & GAGE LC, 4845 PEARL EAST CIRCLE, SUITE 300, BOULDER, CO, 80301, US

(21) Appl. No.: 11/051,953

(22) Filed: Feb. 4, 2005

Related U.S. Application Data
(60) Provisional application No. 60/544,918, filed on Feb. 17, 2004.

(51) Int. Cl. H04L 9/00

(52) U.S. Cl. 713/200

(57) ABSTRACT

Provided is a computer security peripheral. The device includes a proximity sensor operable to detect the presence of a user. In addition, a computer interface connector operable to transfer information between the device and the computer is provided. A controller is coupled to the proximity sensor and the computer interface connector. The controller is operable to generate signals transferred to the computer by the interface controller to perpetuate operation of a computer program. A method of use is also provided.

### RELATED APPLICATION

This application is a continuation-in-part of Provisional Patent Application Ser. No. 60/544918 filed Feb. 12, 2004 for its filing date.

### FIELD OF THE INVENTION

This invention relates generally to computers and, more specifically, the invention relates to a computer interface apparatus and method which utilize a motion sensor that senses that the user is in the immediate vicinity of the computer.

### BACKGROUND

Computer security is of great concern to businesses and users who rely upon computer systems for business and personal activities. Confidential information present in an active computer is often safeguarded by placing the computer in a password-protected state. Frequently such a state is provided by a screensaver application that serves to protect the computer screen, prevent visual observation of confidential information, and requires the user of the computer to supply a password before access to information can be achieved. Activation of a screensaver or other security application is typically triggered by the absence of input activity for a specified period of time.

When the user of a computer is occupied with other activities, such as reading a long document, conversing, or the like, the computer can lapse into a password-protected security mode due to the lack of keyboard, mouse, or other input peripheral activity. This is often annoying for the user. To avoid such annoyance and the inconvenience of frequently re-entering a password, many users extend the time period interval for inactivity that is used to engage the screensaver or other security application.

While this permits the user to enjoy greater passive use of his or her system while proximate to the computer (e.g. reading the screen), the extended time period also provides greater opportunity for unauthorized computer use or observation when the user leaves the proximity of the computer.

Several prior art devices have attempted to solve this security problem. U.S. Pat. No. 5,281,961 to Elwell discloses a ceiling sensor to interface with the computerized controllers of energy management systems. This ceiling sensor is operable to detect motion through the use of a transmitted signal of predetermined frequency which, when received, has experienced a Doppler shift. Comparison of the received signal with its frequency change to the transmitted signal produces motion detection which, when incorporated with an isolated latching relay, enables the switching on and off of light, heating, air conditioning or security interfaces. A method of fabricating a ceiling sensor for a computer controller interface is also described.

U.S. Pat. No. 5,635,905 to Blackburn et al. discloses a system for detecting the presence of a human who may be observing an artifact which is within his or her line of sight or field of view. The system includes a laser with a lens at the output and which is triggered rapidly in order to produce a pulsed beam having divergent rays or visible or invisible infrared light which irradiates an area to be examined for the presence of an observer. The light reflected from the individuals and objects in the area is reflected into a pair of vision devices or pair of vision assemblies, the output of which are fed into a computer. The computer has software programs which utilize vision device output data to the intensity and location of the light pixels in the image thereof to detect the presence and orientation of the eyes of an individual in the area based on the light pixel intensity and location data.

U.S. Pat. No. 6,374,145 to Mark Lignoul discloses a proximity sensor-based control system that is operative to detect the physical presence of a user and to transmit a signal indicative of the presence of the user to prevent a computer program from being activated. The device is connected to a computer input interface and is intended to be interposed between the computer and a user input device such as a mouse or keyboard. Utilizing a port in common with another user input device, the security device signals momentarily interrupt the signals from the user input device. Although of short duration, such interruption can be problematic, such as, for example, leading to errant mouse and keyboard behavior. The device is also passively reliant upon the user to establish the time interval for the screensaver. Thus, despite signals detecting the presence or absence of a user proximate to the computer, the benefit of the device as a security measure may be undermined by the user's intentional or unintentional choice of a time interval.

A number of systems have been heretofore suggested and/or utilized wherein computer security is heightened when a presence in the vicinity of a secured station is indicated (see U.S. Pat. Nos. 6,002,427, 5,202,929, and 5,548,660). Presence or motion detection has also been utilized to cause suspension of computer function as a power-saving strategy (see U.S. Pat. Nos. 5,835,083 and 5,926,404). However, no systems have been heretofore suggested for perpetuating an application during a user's proximate existence without the possibility of interrupting the signals from a user input device, or for ensuring that the security measures are engaged in an appropriate timely manner upon the user's departure from the proximity of the computer.

Hence, there is a need for a security device that overcomes one or more of the drawbacks identified above.

### SUMMARY

This invention provides a computer security peripheral.

In particular, and by way of example only, according to an embodiment of the present invention, provided is a computer security device including: a proximity sensor operable to detect the presence of a user; a computer interface connector operable to transfer information between the security device and the computer; a controller coupled to the proximity sensor and the computer interface connector; the controller being operable to generate signals transferred to the computer by the computer interface connector, to perpetuate operation of a computer program.

In yet another embodiment, the invention may provide a computer security method for use with a computer including security software normally operational to secure the computer when no user input to the computer occurs for a period of time, the device including: sensing presence of a user in a selected vicinity of the computer; generating a signal to the computer in response to the presence of a user during the time interval, the signal operating to perpetuate the operation of a computer program as a priority to the security software, the signal transferred concordantly with other user input; and accommodating normal operation of the security software in the absence of a user during the time interval.

### BRIEF DESCRIPTION OF THE DRAWINGS

FIG. 1 illustrates a high level block diagram of a computer security peripheral coupled to a computer in accordance with an embodiment;

FIG. 2 is a more detailed block diagram of the security peripheral shown in FIG. 1 in accordance with an embodiment.

FIG. 3 is a flow diagram describing a method of operation employed by the security peripheral of FIG. 2 in accordance with an embodiment;

FIG. 4 is a flow diagram describing a method of operation employed by the security peripheral of FIG. 2 in accordance with an alternative embodiment; and

FIG. 5 is a flow diagram describing a method of operation employed by the security peripheral of FIG. 2 in accordance with yet another alternative embodiment.

### DETAILED DESCRIPTION

Before proceeding with the detailed description, it is to be appreciated that this present teaching is by way of example, not by limitation. The concepts herein are not limited to use or application with a specify type of computer security peripheral device and/or method. Thus, although the instrumentalities described herein are for the convenience of explanation, shown and described with respect to exemplary embodiments, it will be appreciated that the principles herein may be applied equally in other types of computer security peripheral device and/or methods.

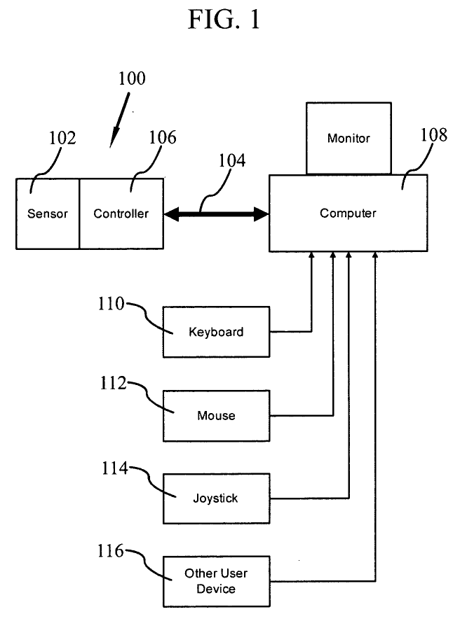

Referring now to the figures, FIG. 1 is a high level block diagram overview of the computer system peripheral (“CSP”) 100. In at least one embodiment, CSP 100 has a proximity sensor 102, a computer interface connector 104, and a controller 106. Proximity sensor 102 is operable to detect the presence of a user in the immediate vicinity of the computer 108.

Proximity sensor 102 is appreciated to be any sensor that can detect the physical presence of a user within the vicinity of the computer 108. Such a proximity sensor 102, may be, but is not limited to, an infrared motion detector, a pressure mat, a micro-switch in the user's chair, ultrasonic sensors, reflectance sensors, or the like. In at least one embodiment, proximity sensor 102 is an infrared sensor. Further, proximity detector 102 may be user configurable to adjust the size and scope of the proximity area.

Controller 106 is coupled to the proximity sensor 102 and interface connector 104. As such, the controller 106 is coupled to the computer 108 by interface connector 104. The controller is operable to generate signals transferred to the computer 108 by the computer interface connector 104 to perpetuate operation of a computer program. As will be further discussed below, in at least one embodiment, controller is also capable to query computer 108 for information.

Computer interface connector 104 may be a serial port cable and connector, a parallel port cable and connector, a wireless transmitter (such as but not limited to, WiFi transmitter, Bluetooth transmitter, IR transmitter, etc . . . ) or a universal serial bus (“USB”) cable and connector. Moreover, the interface connector 104 is appreciated to be any interface connector which may be used to transmit signals from the controller 106 to the computer 108 and vice versa, as may be desired in specific embodiments.

In at least one embodiment, computer interface connector 104 is a USB cable and connector. Under contemporary USB architecture one-hundred-twenty-seven devices may be connected to the computer 108. Described generally, USB cables provide four wires, a +5 volt and ground power pair and a twisted pair for carrying signals representative of data. As the power pair supply up to five-hundred milliamps of power at five volts, CSP 100 draws power directly from computer 108 and does not require additional external or internal power supply systems such as a transformer or batteries. In an alternative wireless configuration, CSP 100 is provided with auxiliary power, such as from a battery or wall adapter.

Computer 108 may be a commercially available system such as a laptop or desktop workstation unit provided by IBM, Dell Computers, Gateway, Apple, Sun Micros Systems, or other computer system provider. Computer 108 may also be a networked computer system. Those skilled in the art will understand and appreciate that physical composition of components and component interconnections comprising computer system 108, are not of significant concern with respect to CSP 100.

As illustrated, various user input devices are connected to computer 108. Specifically, a keyboard 110, mouse 112, and joystick 114 and/or other user devices 116 are connected to computer 108. As is shown, CSP 100 is not interposed between any user device 110˜116 and the computer 108. Indeed, in at least one embodiment, the operation and function of CSP 100 is not predicated on a user device 110˜116 being present, although such devices may certainly be present. 100271 As CSP 100 is not interposed between the computer 108 and a user input device 110˜116, signals from user input devices 110˜116 are not interrupted or directly monitored in their transmission to computer 108. As CSP 100 is connected to its own computer port, the signals from CSP 100 do not inhibit the computer 108 from receiving user input from user input devices 110˜116. It is understood and appreciated that as few computer systems may provide one-hundred-twenty-seven physical USB ports, UBS hubs may be employed with computer 108. Whether connected directly to computer 108 or through a USB hub, CSP 100 will not inhibit the computer 108 from receiving user input from user input devices 110˜116.

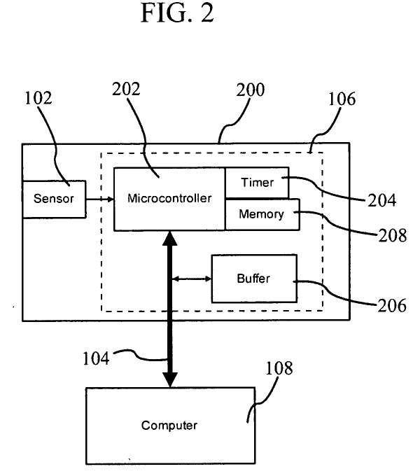

FIG. 2 is a more detailed illustration of an exemplary embodiment of CSP 100. Within a housing 200, is provided proximity sensor 102 coupled to controller 106. The controller 106 may be implemented in a number of different ways. A suitable controller 106 may be comprised of analog circuitry, a digital processor, a CPU programmed with control logic, and combinations thereof.

As shown for at least one embodiment, controller 106 consists of a microcontroller 202 or finite state machine (“FSM”), a timer 204, a buffer 206 and a memory 208. A suitable microcontroller 202 is, for example, a CYPRESS CY37064P44-100JC CPLD). A suitable timer 204 consists of an integrated circuit such as a 74HC123 mono-stable chip paired with an oscillator such as a FOX X052B100 1 Mhz TTL clock, together providing a fifteen second timer. Memory 208, if provided, is preferably a non-volatile commercially available memory store of suitable storage size to accommodate the holding of user configurable preferences and/or data to be transmitted to the computer 108.

When in operation, contemporary computers typically execute a plurality of applications such as, for example, an operating system, a primary application and a secondary application. At the simplest level, and in the most general sense, the tasks of the operating system fall into specific categories—process management, device management (including application and user interface management) and memory management.

Primary applications are typically those in direct use by a user, such as, for example, a word processing application or spreadsheet application. Secondary applications are typically those not in direct use, such as, for example, a screensaver or other security application. When a user is actively engaged in use of the computer, the current program state of the computer may be describe as the primary application being in the foreground while the secondary application is in the background.

In the absence of active use by the user in an established interval of time, the current program state may be directed to change. Where the secondary application is a screensaver or security application, typically the state is changed to place the secondary application in the foreground and the primary application in the background. For security purposes, typically the state may only be reversed by supplying a password or other form of authorization.

In computing, multitasking is a method by which multiple tasks, also known as processes, share common processing recourses such as the CPU. At any point in time, only one task is actually said to be running, meaning that the CPU is actually executing instructions for that task. Multitasking solves the problem by scheduling which task may be the one running at any given time, and when another waiting task gets a turn. The act of reassigning a CPU from one task to another one is called a context switch. When context switches occur frequently enough, the illusion of concurrency in operation is achieved, as each process is incrementally advanced.

Computer 108 will accept input signals, such as from a mouse or keyboard, on more than one interface port. As such, CSP 100 can send artificial user input, also known as spoofed data, that will be accepted by the computer 108 and acted upon as if it had come from an actual user input device. Conventional mouse technology permits the use of two-hundred-fifty-five different mouse buttons in addition to horizontal and vertical motion information.

In at least one embodiment, spoofed mouse data may therefore be in the form of an uncommon mouse button click. In an alternative embodiment, such spoofed mouse data may indicate mouse movement in a first direction followed shortly thereafter by a mouse movement in the opposite direction. It is this spoofed data sent by CSP 100 that serves to perpetuate the current program state of the computer.

In at least one embodiment, this spoofed data sent by CSP 100 serves to perpetuate the current state of the primary application. For such purposes, it is immaterial whether there are other secondary applications at all and which is or is not in the foreground or background. In at least one embodiment, this spoofed data sent by CSP 100 serves to perpetuate the current state of the primary application in the foreground and the secondary application in the background when the user is proximate to computer 108.

As the CPU is capable of acting upon only one task at a time, it is possible that the spoofed data from CSP 100 will be received concordantly with real user input. Such concordant data is buffered momentarily so as not to be lost. Whether it is the spoofed data from CSP 100 or the actual user data that is buffered is immaterial for, to the perceptions of the user, his or her input data is not lost or altered.

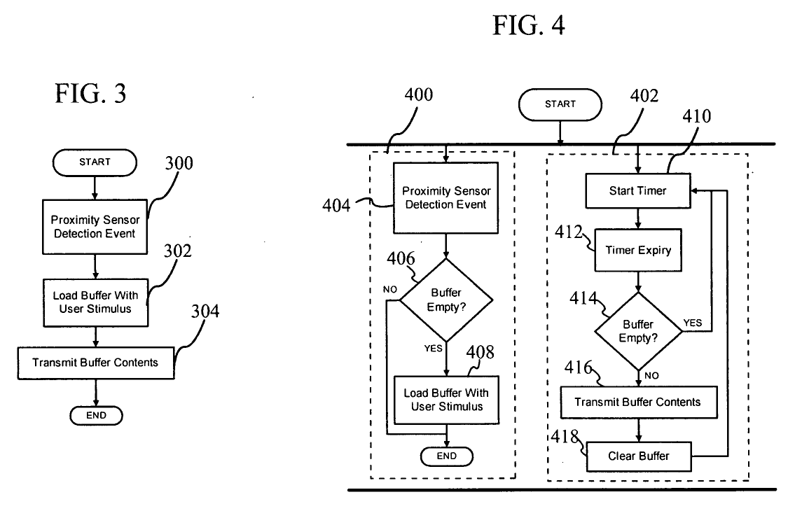

CSP 100 may respond to the presence of a user in at least one of three ways. FIGS. 3˜5 illustrate different methods of operation. It will be appreciated that the described events and methods of operation need not be performed in the order in which they are herein described, but that this description is merely exemplary of one or more methods of operation in accordance with at least one embodiment.

FIG. 3 illustrates a flow diagram for one embodiment wherein CSP 100 is configured to generate and transfer spoofed data to computer 108 each time the user's presence is detected (such as by detecting motion). Specifically, the presence of a user triggers a Proximity Sensor Detection Event, block 300, that initiates the loading of the buffer with spoofed user stimulus, block 302. The user stimulus is then transmitted from the buffer to the computer, block 304. Such a configuration may be desired for its simplicity.

The sending of the spoofed data serves to perpetuate the current program state of the primary software as a priority to the secondary software so long as the user is proximate to the computer. In the absence of the user and, thus, the absence of spoofed data being transmitted to the computer, the normal operation of the secondary software is accommodated.

In an alternative embodiment illustrated by the flow diagram of FIG. 4, CSP 100 is configured to generate and transfer spoofed data to computer 108 at specified time intervals if the presence of a user has been detected in that interval. Two processes are concurrently in operation within CSP 100: a sense operation 400 and a timer operation 402, thus illustrated between parallel processing lines. The presence of a user triggers a Proximity Sensor Detection Event, block 404. If the buffer is empty, decision 406, it is loaded with spoofed user stimulus, block 408. If the buffer is already loaded, there is no reason to reload it.

A countdown timer is also started, block 410. The time interval utilized is typically less than one minute, and may be user configurable. Upon expiration of the timer, block 412, the status of the buffer is reviewed, decision 414. If the buffer is not empty, the spoofed user data is transmitted from the buffer to the computer, block 416, and the buffer is cleared, block 418, and the timer reset and started. The sending of the spoofed data serves to perpetuate the current program state of the primary software as a priority to the secondary software.

If a user has not been detected proximate to the computer by the sense operation 400, the buffer will be evaluated as empty, decision 414, and no spoofed data will be transmitted to the computer. As such, CSP 100 accommodates the normal operation of the secondary software in the absence of a user. The return of a user to the proximity of the computer will then again trigger the loading of the buffer without requiring the user to re-initialize the CSP 100. Such a configuration may be desired for both its simplicity and less frequent transmissions than the embodiment of FIG. 3.

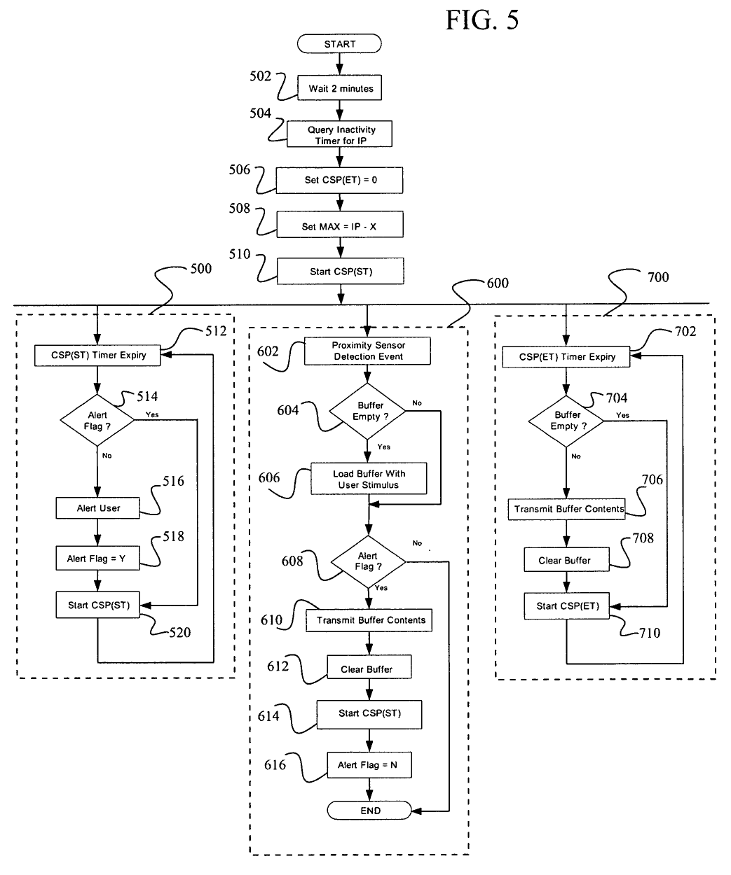

Yet another alternative embodiment illustrated by the flow diagram of FIG. 5. CSP 100 is configured to generate and transfer spoofed data to computer 108 periodically so long as a user presence is detected. Three processes are concurrently in operation within CSP 100, a timer operation 500, a sense operation 600, and a timer operation 700.

Timer process 500 is operative to optionally alert the user that activation of the security application in computer 108 is imminent. Timer CSP(ST), the synchronization timer, is a timer/counter that times from zero up to a maximum value, MAX, at which point the timer expires. Sense operation 600 is operative to load a buffer with user stimulus and if an optional alert state is current, transmits the contents of the buffer. Timer operation 700 is operative to periodically transmit the contents, if any, of the buffer. Timer CSP(ET), the Proximity Sensor Detection Event timer, is a timer/counter that times from zero up to a maximum value, X, at which point the timer expires.

In this configuration, the controller of CSP 100 waits a two minute warm up period, block 502, then polls the computer to determine the current inactivity period (IP), block 504. The CSP(ET) timer is then initialized to zero, block 506. The maximum value, MAX, for timer CSP(ST) is set for a time interval IP-X, block 508, and CSP(ST) is started, block 510. For example, IP may be sixty seconds and X may be five seconds, CSP(ST) timer interval therefore is set for fifty-five seconds.

In process 500, upon expiration of timer CSP(ST), block 512, the status of the Alert Flag is tested, decision 514. If the Alert Flag is already set, then CSP(ST) is restarted, block 520. Otherwise, the user is optionally alerted that activation of a security application is imminent, block 516, the Alert Flag is asserted, block 518, and CSP(ST) is restarted, block 520.

In process 600, when a Proximity Sensor Detection Event Occurs, block 602, it is determined if the buffer is already loaded with a user stimulus, decision 604. If the buffer is empty, it is loaded with a user stimulus, block 606. In either case, a determination is made if the Alert Flag is set, decision 608. If the Alert Flag is not set, then the process ends without taking further action. Otherwise, if the Alert Flag is set, then the contents of the buffer is immediately transmitted to the computer 108, block 610, the buffer is cleared, block 612, timer CSP(ST) is started, and the Alert Flag is cleared, block 616 before the process ends. Immediate transmission of the buffer contents is needed to prevent imminent assertion of the computer 108 security application.

In process 700, timer CSP(ET) expires upon reaching value X. Upon expiration of timer CSP(ET), block 702, a determination is made if the buffer is empty, decision 704. If the buffer is empty, then the timer CSP(ET) is restarted, block 710, without further action. Otherwise, if the buffer is not empty, then the contents are transmitted, block 706, the buffer is cleared, block 708, and the timer CSP(ET) is restarted, block 710. The sending of the spoofed data serves to perpetuate the current program state of the primary software as a priority to the secondary software.

The three processes, process 500, process 600, and process 700, work in concert to limit the number of transmissions of spoof data to the computer 108 to at most once every X seconds. Further, if no proximity events are detected just prior to a time when assertion of security application seems imminent, the user may optionally be alerted, and any proximity detection events will cause spoof data to be immediately transmitted thus preventing such security application assertion.

If a user has not been detected proximate to the computer by the sense operation 600, the buffer will be evaluated as empty, decision 604 and no spoofed data will be transmitted to the computer. As such, the normal operation of the secondary software is accommodated. The return of a user to the proximity of the computer will then again trigger the loading of the buffer without requiring the user to re-initialize the CPS 100. Such a configuration may be desired for both its simplicity and less frequent transmissions than the embodiment of FIG. 4.

Each of the above embodiments of operation may be summarized as conforming to the same general embodiment principles. Namely, that CSP 100 embodies a method for use with a computer including security software normally operational to secure the computer when no user input to the computer occurs within an interval of time. This method includes sensing the presence of a user in a selected vicinity of the computer. In response to the presence of a user during the interval of time a generated signal of spoofed data is transferred to the computer. This signal operates to perpetuate the current program state of the primary software as a priority to the secondary software. In the absence of user during the interval of time, normal operation of the secondary software is accommodated.

As stated above, the computer's inactivity timer is restarted each time the computer receives user input. Typically, when a user input device transmits data to the computer 108, the arrival of such data is registered as an interrupt flag or notation in the BIOS, the basic-input-output-system. Just at the computer's inactivity timer may be reset by the interrupt flag, in at least one embodiment, CSP 100 loads a memory resident applet to the computer which will respond to the same interrupt flag and instruct the CSP timer to reset as well.

The inactivity time value is commonly stored in the computer's registry. For example, in a exemplary case of a Windows™ setting, the inactivity time period used to change the state to the screensaver is stored in the computer registry as:
HKEY_CURRENT_USER/Control Panel/Desktop/ScreenSaveTimeOut 480
   where “480” is a duration measured in seconds. Additional ScreenSaveTimeOut variables may also be recorded under:
HKEY_USERS/.DEFAULT/Control Panel/Desktop

In the above example, the ScreenSaverTimeOut value has been set for eight minutes. Although this may accommodate the preferences of the user, such a setting would permit the user to be absent from the system for a considerable length of time before the computer would change state, thus providing a potential opportunity for unauthorized use of the computer system and/or its data.

In at least one embodiment, CSP 100 is operable to query the computer for application specific activation time values, such as the ScreenSaverTimeOut value. Such query ability may be used to establish the CSP timer interval discussed above. Such query ability may also be used to determine the appropriateness of a CSP over-ride. More specifically, in at least one embodiment, the controller 106 of CSP 100 is operable to direct the computer to set application specific activation time values, such as the ScreenSaverTimeOut value. CSP 100 may be configured to reset the application activation time value without first performing a query, or CSP 100 may query the computer to first determine if the application activation time value is within a predetermined acceptable range.

In at least one embodiment, CSP 100 when attached to a USB input port will provide computer 108 with all required drivers and software components necessary for operation of CSP 100. In an alternative embodiment, a user may be provided with supplementary software to be installed upon the computer 108. Whether installed by a user, or auto-installed by CSP 100 when connected, the software may provide a user with the ability to configure the sensitivity of the proximity detector, the CSP timer values, as well as other features and operations that may be provided by CSP 100, such as, for example, visual and audio alerts that spoofed data is being transmitted or about to be transmitted.

With respect to the above descriptions, it is further understood that CSP 100 may have at least three distinct operation modes (OM#):
OM1. a mode where periodically spoofed data can be sent only as long as the detector senses the presence of a person at the workstation;
OM2. a mode where a series of keystrokes are sent (after an optional timing period) to the workstation to immediately lock it down should the detector sense the lack of a person at the workstation; and
OM3. to send spoofed data whether or not a person is at the workstation. This last mode may be of interest to the home computer market where a user does not want a remote connection timed out because the user left the area temporarily (for example, an internet connection could remain active while the user takes a personal break away from the workstation. Such a configuration further examples the advantageous focus of perpetuating the current state of the computer.).

Another aspect is that CSP 100 may either be manufactured to exclusively perform one of the above functions, or their functions could be embodied in one device that is programmable to operate in any one of the above described modes. Programming could be accomplished through hardware switch settings, or come through the keyboard or computer to which it interfaces. Programming would not only include which mode, but could also include which keystroke would represent the unobtrusive keystroke described above (default to shift enable, shift disable perhaps), changes to default timing parameters between keystrokes, and for mode 2) above which keystrokes are necessary to accomplish workstation lock up.

In at least one embodiment, CSP 100 is provided with two LEDs to represent which one of the three modes which it is currently operating in (or in the “off” or disabled state). No LED lit means CSP 100 is off-line, out of the loop, or otherwise disabled and is not functionally operational while allowing normal keystroke operations, left LED alone lit means CSP 100 is operating in mode 1) described above, right LED alone lit means CSP 100 is operating in mode 2) described above, and both LEDs lit means CSP 100 is operating in mode 3) described above.

In another embodiment, another LED, of perhaps a different color, could blink on momentarily every time a keystroke is being automatically sent, thus giving the user some assurance that the device is working.

In yet other embodiments, CSP 100 would include an alert to the user in the form of a and/or a visual alert such as a flashing LED when CSP 100 is either getting ready to issue instructions to the system box to engage the screensaver, or when enough time has elapsed that the screensaver activation is near. This could be done in both of two operational modes: OM1-keep screensaver away while user is present; and OM2-engage lockup as soon as the user leaves the area. For OM1, a user could be perfectly still while sitting at the terminal and reading, for example, making it difficult for a motion detector to recognize the presence of the user.

If CSP 100 has not detected motion for perhaps fifty-five (user programmable) seconds (the lowest keyboard inactivity timeout value for a screensaver in Windows98™ is sixty seconds) it could issue a sonic alert. This very act would cause the quiet reader to look up momentarily, providing just enough motion for CSP 100 to reset the keyboard inactivity timer by sending a keystroke to the system box.

For OM2, the sonic alert could serve as a reminder that, in say five (user programmable) seconds, the terminal will be locked up with the password-protected screensaver. If CSP 100 is implemented with a microprocessor as previously discussed, the timing function should provide no real obstacle. From previous work, it is known that some sonic alert modules are available in a variety of functional parameters including price and loudness. Activation of the “sonic reminder” could be another parameter that the user could set up as an option when CSP 100 is first installed.

Changes may be made in the above methods, systems and structure without departing from the scope hereof. In should thus be noted that the matter contained in the above description and/or shown in the accompanying, drawings should be interpreted as illustrated and not in a limiting sense. The following claims are intended to cover all generic and specific features described herein, as well as all statements of the scope of the present method, system and structure, which, as a matter of language, might be said to fall therebetween.

1. A computer security device comprising:
a proximity sensor operable to detect the presence of a user;
a computer interface connector operable to transfer information between the security device and the computer;
a controller coupled to the proximity sensor and the computer interface connector;
the controller being operable to generate signals transferred to the computer by the computer interface connector, to perpetuate operation of a computer program.

2. The computer security device of claim 1, wherein the device is not interposed between the computer and an input peripheral.

3. The computer security device of claim 1, wherein the signals do not inhibit the computer from receiving user input from a user input device.

4. The computer security device of claim 1, wherein the controller is further operable to query the computer for application specific activation time values.

5. The computer security device of claim 1, wherein the controller is further operable to direct the computer to set application specific activation time values.

6. The computer security device of claim 5, wherein the application is a screensaver and the time value for activation is one minute.

7. The computer security device of claim 1, wherein the computer interface connector is a USB connector.

8. The computer security device of claim 1, wherein the proximity sensor is an infrared sensor.

9. The computer security device of claim 1, wherein the signals are spoofed data to perpetuate a current computer state.

10. A computer security device for use with a computer including security software normally operational to secure the computer when no user input to the computer occurs for a period of time, the device comprising:
sensing means for sensing the presence or absence of a user in the immediate vicinity of the computer and for providing proximity signals pertaining to the presence or absence of the user;
interface means for transferring information between the security device and the computer;
control means for receiving proximity signals and responsive thereto transmitting a signal through the interface means to the computer, the signal operating to perpetuate the operation of a computer program, the signal transferred without interruption of other user input.

11. The computer security device of claim 10, wherein the device is not interposed between the computer and an input peripheral.

12. The computer security device of claim 10, wherein the signals do not inhibit the computer from receiving user input from a user input device.

13. The computer security device of claim 10, wherein the computer is secured with a security software routine operable at a time interval, the device further including a set means for reading and/or setting the time interval.

14. A computer security method for use with a computer including security software normally operational to secure the computer when no user input to the computer occurs for a period of time, the device comprising:
sensing presence of a user in a selected vicinity of the computer;
generating a signal to the computer in response to the presence of a user during the time interval, the signal operating to perpetuate the operation of a computer program as a priority to the security software, the signal transferred concordantly with other user input; and
accommodating normal operation of the security software in the absence of a user during the time interval.

15. The method of claim 14, wherein the signals do not inhibit the computer from receiving user input from a user input device.

16. The method of claim 14, wherein the method is embodied in an apparatus that is not interposed between the computer and an input peripheral device.

17. The method of claim 14, further including directing the computer to set a time interval for the security software.

18. The method of claim 14, wherein the signals are spoofed data to perpetuate a current program state of the computer.

19. A computer control method for use with a computer including primary software and secondary software, the secondary software normally operational at a time interval, the device comprising:
setting the time interval for the secondary application to a known value;
sensing presence of a user in a selected vicinity of the computer;
generating a signal of spoofed data to the computer in response to the presence of a user during the time interval, the signal operating to perpetuate a current program state of the primary software as a priority to the secondary software; and
accommodating normal operation of the secondary software in the absence of a user during the time interval.

20. The method of claim 19, wherein the signals do not inhibit the computer from receiving user input from a user input device.

21. The method of claim 19, wherein the method is embodied in an apparatus that is not interposed between the computer and an input peripheral device.

22. A computer security device for use with a computer including security software normally operational to secure the computer when no user input to the computer occurs for a period of time:
a proximity sensor operable to detect the presence of a user;
a computer interface connector operable to transfer information between the security device and the computer;
a controller coupled to the proximity sensor and the computer interface connector; the controller being operable to generate signals transferred to the computer by the computer interface connector, to engage operation of the security program.

23. The computer security device of claim 22, wherein the device is not interposed between the computer and an input peripheral.

24. The computer security device of claim 22, wherein the signals do not inhibit the computer from receiving user input from a user input device.

25. The computer security device of claim 22, wherein the controller is further operable to query the computer for application specific activation time values.
